(19) United States
(12) Patent Application Publication
(10) Pub. No.: US 2026/0202198 A1
(43) Pub. Date: Jul. 16, 2026

(54) MEASUREMENT APPARATUS WITH PENDULUM-BASED PLUMB INDICATION AND FLUID-BASED LEVEL INDICATION

(71) Applicants: Blake Thompson, Hope Mills, NC (US); Keith Thompson, Valparaiso, IN (US); Taylor Thompson, Aberdeen, NC (US)

(72) Inventors: Blake Thompson, Hope Mills, NC (US); Keith Thompson, Valparaiso, IN (US); Taylor Thompson, Aberdeen, NC (US)

(21) Appl. No.: 19/450,704

(22) Filed: Jan. 15, 2026

Related U.S. Application Data
(60) Provisional application No. 63/745,902, filed on Jan. 16, 2025.

(51) Int. Cl. G01C 9/20; G01C 9/12

(52) U.S. Cl. CPC G01C 9/20; G01C 9/12

(57) ABSTRACT

A combined plumb and level measurement apparatus can comprise a housing defining a sealed chamber and a viewing window with at least one transparent face. A fluid interface between a fluid occupying a first volume within the sealed chamber and a headspace above the fluid provides a level reference across the viewing window. A pendulum within the sealed chamber extends through the fluid and is pivotably supported about a pivot axis proximate a geometric center of the sealed chamber, where the pendulum aligns with a direction of gravity independently of an orientation of the housing to provide a plumb reference visible through the viewing window concurrent with the level reference of the fluid interface. Exterior indicia along a housing circumference include at least a first pair of opposed level reference marks and a second pair of opposed plumb reference marks angularly offset from the opposed level reference marks.

### CROSS-REFERENCE TO RELATED APPLICATIONS

This application claims the benefit of U.S. Provisional Application No. 63/745,902, filed Jan. 16, 2025, which is hereby incorporated by reference, in its entirety and for all purposes.

### TECHNICAL FIELD

The present disclosure generally relates to instruments and tools for measurement, and more particularly pertains to an apparatus of a combined plumb and level.

### BACKGROUND

Plumb and level measurements are used in many different fields and applications to ensure a proper or otherwise desired alignment has been achieved. For example, an accurate plumb and level alignment can be important in fields such as construction, carpentry, masonry, etc., among various others. Plumb measurements can correspond to vertical alignment of an edge, surface, object, etc., while level measurements can correspond to horizontal alignment of an edge, surface, object, etc. Typically, plumb alignment refers to a vertical alignment in the direction of gravity, which is perpendicular to the horizontal plane corresponding to the level alignment. Various tools, techniques, and/or devices may be utilized to perform a plumb measurement and/or a level measurement.

For example, existing approaches commonly utilize a bubble level design, where a cylindrical tube or vial is partially filled with a liquid to leave an air pocket (e.g., a bubble) within the sealed tube. Bubble levels may also be referred to as “spirit levels,” or simply “levels,” generally describing various straight edge tools that include one or more bubble chambers that can be used to provide a visual reference or approximation of a surface's horizontal (e.g., level) alignment or vertical (e.g., plumb) alignment. The displacement of the bubble away from a midpoint (or other marked location(s)) along the longitudinal length of the bubble chamber can be used as an indication of the extent to which a surface is or is not in a desired plumb or level alignment. Conventional bubble level designs typically require multiple, separate bubble chambers in order to measure multiple different directions or dimensions. For example, a bubble level tool can include a first bubble chamber that is used for measuring level alignment, and a second bubble chamber that is used for measuring plumb alignment, etc. The accuracy and/or precision of a bubble level tool may be relatively low, and can depend on factors such as the alignment of the bubble chamber with the edges of the straight edge tool at the time of manufacture, as well as subjective user judgments of whether the bubble appears to be visually centered between two marks provided on a surface of the bubble chamber.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

According to at least one illustrative example, a combined plumb and level measurement apparatus is provided, the measurement apparatus comprising: a housing defining a sealed chamber and a viewing window, the viewing window including at least one transparent face of the housing; a fluid disposed within the sealed chamber to occupy a first portion of a volume of the sealed chamber, wherein a fluid interface between the fluid and a headspace above the fluid provides a level reference across the viewing window; a pendulum disposed within the sealed chamber and pivotably supported for rotation about a pivot axis located at or proximate a geometric center of the sealed chamber, wherein at least a portion of the pendulum extends through the fluid, and wherein the pendulum is configured to align with a direction of gravity independently of an orientation of the housing to provide a plumb reference visible through the viewing window concurrently with the level reference provided by the fluid interface; and a plurality of exterior indicia disposed along a circumference of the housing and adjacent the viewing window, the plurality of exterior indicia including at least: a first pair of opposed level reference marks corresponding to the level reference, and a second pair of opposed plumb reference marks angularly offset from the first pair of opposed level reference marks.

In some aspects, the pendulum is visible through the viewing window and is configured to align with the direction of gravity independently of the orientation of the housing such that the measurement apparatus concurrently provides the plumb reference by the pendulum and the level reference by the fluid interface.

In some aspects, the fluid interface provides the level reference based on the fluid interface forming a horizontal reference plane across the viewing window in response to a gravitational force in the direction of gravity with which the pendulum is configured to align.

In some aspects, a longitudinal length of the pendulum is less than an inner radius of the sealed chamber by a clearance gap configured to permit free 360-degree rotation of the pendulum without contact between a distal end of the pendulum and an inner wall of the sealed chamber.

In some aspects, the pendulum includes a body portion having one or more drag-reducing apertures configured to permit the fluid to pass through the pendulum during rotation of the pendulum about the pivot axis and within the sealed chamber.

In some aspects, a surface area corresponding to the drag-reducing apertures is greater than or equal to half of a total surface area of the body portion of the pendulum.

In some aspects, the pendulum includes a fluorescent material or includes at least one fluorescent edge or surface to provide increased contrast relative to the fluid occupying the first portion of the volume of the sealed chamber.

In some aspects, the measurement apparatus further includes a pivot support coupled to the housing and engaged with the pendulum to pivotably support the rotation of the pendulum about the pivot axis, wherein the pivot support aligns a first distal end of the pendulum with the pivot axis.

In some aspects, the pivot support includes a column having a first distal end coupled to the housing along an inner surface of the sealed chamber and having a second distal end disposed at or proximate the geometric center of the sealed chamber, wherein the pendulum is rotatably coupled to the pivot support at the second distal end of the column.

In some aspects, the pivot axis and the pivot support extend between a first attachment point located at or proximate the geometric center along a first transparent face of the housing and a second attachment point located at or proximate the geometric center along a second transparent face of the housing, and wherein the first and second transparent faces include the viewing window.

In some aspects, the pendulum is pivotably supported for rotation by a crossbar aligned with the pivot axis and extending between a first recess located at or proximate the geometric center on a first transparent face of the viewing window, and a second recess located at or proximate the geometric center on a second transparent face of the viewing window.

In some aspects, the pendulum includes the crossbar and a pendulum body perpendicular to the crossbar; a first distal end of the crossbar is configured for engagement within the first recess on the first transparent face; and a second distal end of the crossbar is configured for engagement within the second recess on the second transparent face.

In some aspects, the plurality of exterior indicia further includes at least one of: a set of roof-pitch reference marks disposed about a lower portion of the circumference of the housing and adjacent the viewing window, wherein the set of roof-pitch reference marks includes respective indicia corresponding to at least two pitches selected from the group consisting of 2/12 pitch, 4/12 pitch, 6/12 pitch, 8/12 pitch, 10/12 pitch, and 12/12 pitch; and an angle scale including a set of angular reference marks disposed about an upper portion of the circumference of the housing and adjacent the viewing window, wherein the set of angular reference marks includes respective indicia corresponding to at least two angular values selected from the group consisting of 22.5 degrees, 30 degrees, 45 degrees, and 60 degrees.

In some aspects: the plurality of exterior indicia include at least cardinal markings corresponding to 0-degrees, 90-degrees, 180-degrees, and 270-degrees about the circumference of the housing; and the first pair of opposed level reference marks and the second pair of opposed plumb reference marks are selected from the group consisting of the cardinal markings.

In some aspects, at least a portion of the exterior indicia are integrally formed with an exterior surface of the housing, and wherein a width of at least one marking included in the plurality of exterior indicia is equal to a thickness of the pendulum.

In some aspects: the fluid interface is formed between the fluid occupying the first portion of the volume of the sealed chamber and a second fluid occupying the headspace above the first fluid, the headspace including a remaining portion of the volume of the sealed chamber; and the fluid and the second fluid are non-miscible to thereby provide the fluid interface as a substantially horizontal liquid interface across the transparent face of the viewing window when the measurement apparatus is at rest.

In some aspects, the level reference includes a horizontal reference plane defined by a gas-fluid interface between the fluid occupying the first portion of the volume and a gas or reduced-pressure vacuum space at sub-atmospheric pressure occupying the headspace above the fluid and having a density less than a density of the fluid.

In some aspects: the fluid disposed within the sealed chamber has a viscosity selected to damp rotational motion of the pendulum toward a stable alignment; the fluid disposed within the sealed chamber has a freezing point below a freezing point of water; and the fluid disposed within the sealed chamber occupies between 40 percent and 60 percent of a total internal volume of the sealed chamber.

In some aspects: the housing includes a resealable fill port in fluid communication with the sealed chamber, the resealable fill port extending between the volume of the sealed chamber and an exterior surface of the housing.

In some aspects, the resealable fill port includes a self-sealing elastomeric septum configured to be penetrated by a needle or tubular filling device for at least one of filling the sealed chamber by introducing a volume of the fluid via the resealable fill port, or removing a portion of an introduced volume of the fluid via the resealable fill port to thereby provide the headspace above the fluid.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. Devices incorporating described aspects and features may include additional components and features for implementation and practice of claimed and described aspects. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1A is a diagram illustrating an example front view and an example side view of a combined plumb and level measurement apparatus including a pendulum-based plumb indication and fluid-based level indication, in accordance with some examples;

FIG. 1B is a diagram illustrating an example perspective view of a pendulum component that may be used to indicate plumb alignment, in accordance with some examples;

FIGS. 2A-C are diagrams illustrating various example views of a combined plumb and level measurement apparatus with a combined or integrated pendulum-based plumb indication and fluid-based level indication, in accordance with some examples;

FIGS. 3A and 3B are diagrams illustrating perspective views of another example of a combined plumb and level measurement apparatus with a combined or integrated pendulum-based plumb indication and a fluid-based level indication, in accordance with some examples;

FIGS. 4A-4B are diagrams illustrating front views of another example of a combined plumb and level measurement apparatus with a combined or integrated pendulum-based plumb indication and a fluid-based level indication, in accordance with some examples;

FIGS. 5A-5B are diagrams illustrating example views of a combined plumb and level measurement apparatus comprising a straight edge chassis or frame with a combined or integrated pendulum-based plumb indication and a fluid-based level indication, in accordance with some examples; and

FIG. 6 is a diagram illustrating an example cutaway view of a pendulum that can be implemented in a combined plumb and level measurement apparatus with a combined or integrated pendulum-based plumb indication and a fluid-based level indication, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various aspects of the present disclosure are described below.

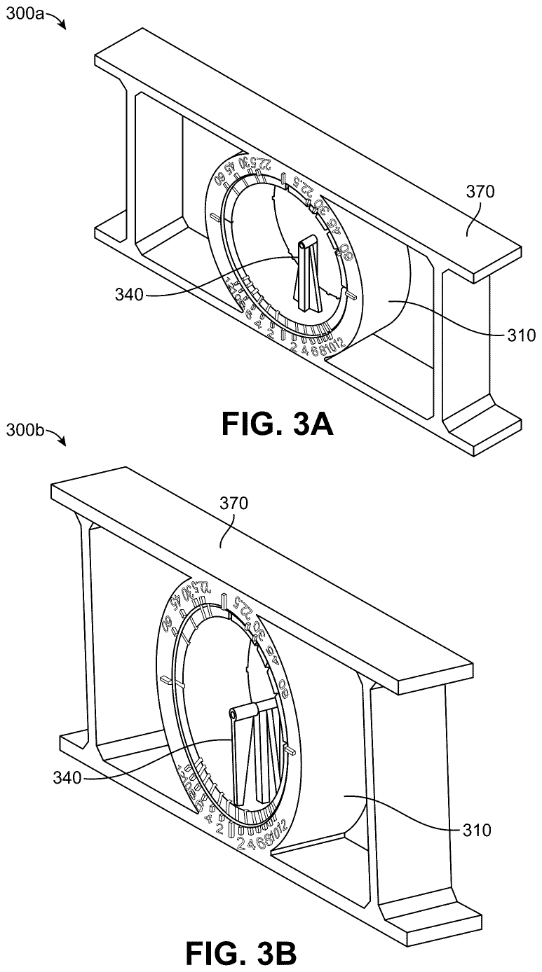

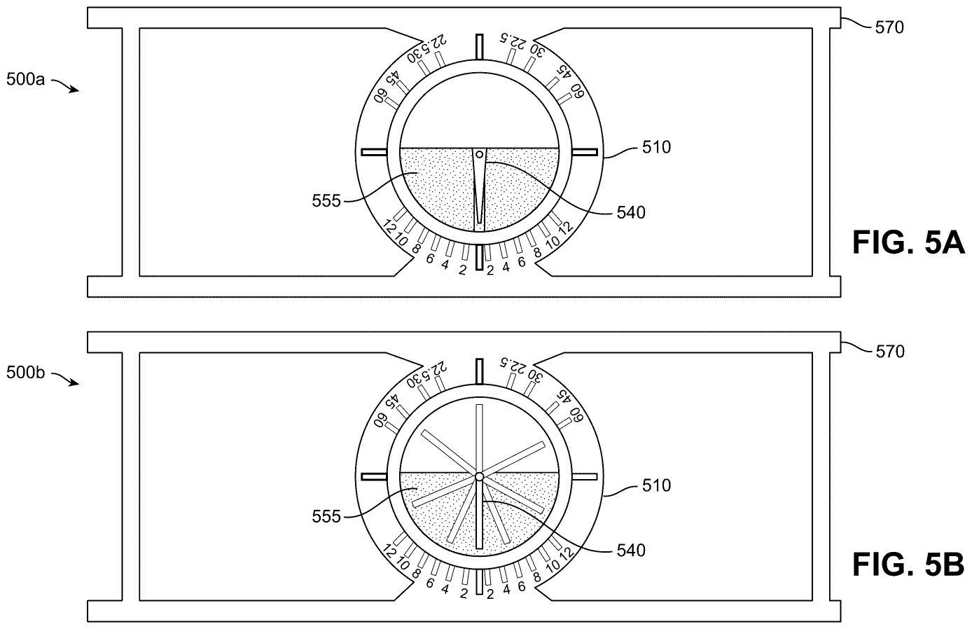

In some embodiments, described herein is a measurement apparatus that includes a plumb measurement portion (also referred to as a “plumb” or “plumb alignment” portion) and a level measurement portion (also referred to as a “level” or “level alignment” portion). The measurement apparatus can be implemented as an independently-contained apparatus for example in a hand tool form factor, etc., among various others. In one illustrative example, the measurement apparatus can be implemented as a plumb and level measurement device that is integrated within or otherwise coupled to, included within, associated with, etc., a straight edge (e.g., such as in the examples of FIGS. 3A and 3B, and/or FIGS. 5A and 5B, among various others, etc.). As used herein, the described measurement apparatus with plumb measurement portion and level measurement portion may also be referred to as a combined plumb and level measurement apparatus.

The plumb measurement portion of the apparatus and the level measurement portion of the apparatus can utilize different mechanisms for providing a measurement or indication of alignment (or lack of alignment) from plumb or level, respectively. For example, the plumb measurement portion of the apparatus can utilize a gravity-based mechanism such as a suspended pendulum that is free to rotate (and therefore align) with the direction of gravity based on rotation about a central axis or pin at a distal end of the pendulum. Further details and examples of the pendulum-based plumb measurement portion of the apparatus are described below.

In some embodiments, the plumb measurement portion utilizes the gravity-based or pendulum-based indication for plumb alignment, while the level measurement portion utilizes a fluid level-based indication for horizontal level alignment. For example, the apparatus can include an annular tube that is filled with a first fluid and a second fluid. The annular tube can be referred to as a fluid level, a liquid level, a water level, etc. In some cases, the first fluid and the second fluid are both liquids at room temperature and/or within an expected operating temperature range of the apparatus. In some examples, one of the first and second fluid is a liquid while the remaining one of the first or second fluid is a gas. The annular fluid-filled tube can be filled to 50% volume with the first fluid and 50% volume with the second fluid, such that the horizontal level plane or alignment reference provided for the horizontal level alignment is determined by the plane formed between the height of the fluid boundary (e.g., between the first and second fluids that combine to comprise 100% of the enclosed volume within the annular tube) on either side of the annular ring. In some embodiments, the plumb measurement portion of the apparatus is disposed within a center aperture of the annular fluid-filled ring, such that the annular fluid-filled ring for level measurement is located about or along a circumference of a circular housing of the pendulum-based plumb measurement portion of the apparatus. In some embodiments, the plumb and level measurement apparatus disclosed herein can include the plumb measurement portion and the level measurement portion within a single and/or integrally formed housing. In some embodiments, the plumb measurement portion and the level measurement portion of the apparatus may be implemented as two separate components (or sub-components) of an overall housing or enclosure of the apparatus.

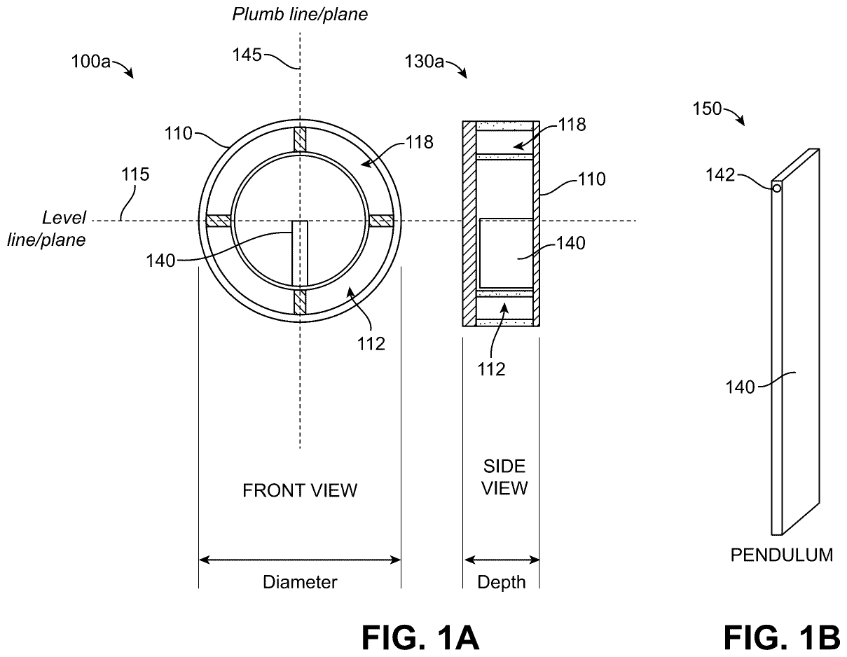

In some examples, FIGS. 1A-6 collectively depict and/or correspond to examples of a measurement apparatus organized around a circular vial that provides a common core for both retrofit and/or integrated products and implementations, where the vial cooperates with a centrally suspended pendulum and a volume of damping liquid filled to about one-half of an internal chamber to yield plumb and level references. The term circular vial, as used herein, may be used to refer to a generally disc-shaped housing that defines a sealed chamber in which liquid and a pendulum are arranged to generate visual alignment references.

Examples of such circular vial constructions can include, without limitation, a molded plastic body with a transparent window, a machined metal ring with a laminated lens, or a glass annulus bonded to polymer backplates, among various others. A damping liquid (or fluid), as used herein, may refer to a fluid within the vial that provides viscous damping of pendulum motion and whose upper surface establishes a stable horizontal reference for determining a measurement and/or indication of a horizontal level line or plane, when the chamber is filled to about one-half of its volume. Examples of such damping liquids may include, without limitation, glycol solutions, mineral oils, silicone oils, and/or alcohol-based fluids selected for viscosity and low-temperature performance, among various others. The term straight edge frame, as used herein, may refer to an elongate structural member that supplies planar reference surfaces and receives the vial to form a hand tool for layout and alignment. Examples of such straight edge frames can include, without limitation, I-beam aluminum extrusions, box-section polymer rails, and/or composite beam members, among various others.

The term exterior indicia, as used herein, may refer to markings on an exterior ring or housing face that are read against the pendulum and the fluid interface to convey cardinal positions and measurement values, etc. Examples of such exterior indicia can include, but are not limited to, molded tick marks, etched scales, and/or printed angle or pitch graphics, etc., among various others. The term retrofit module, as used herein, refers to a standalone vial sized and shaped to replace a conventional bubble vial in an existing level body without redesign of the frame. Examples of such retrofit modules may include, but are not limited to, vials sized to standardized circular openings, vials supplied with adapter collars, and/or vials configured with gasketed rims for press-fit installation, etc., among various others.

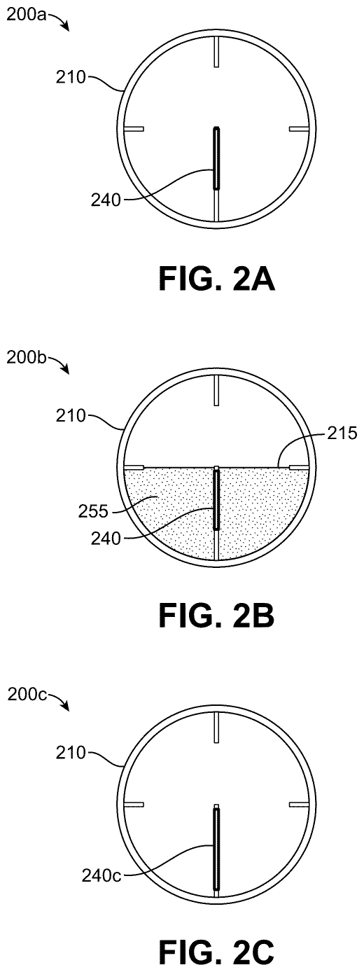

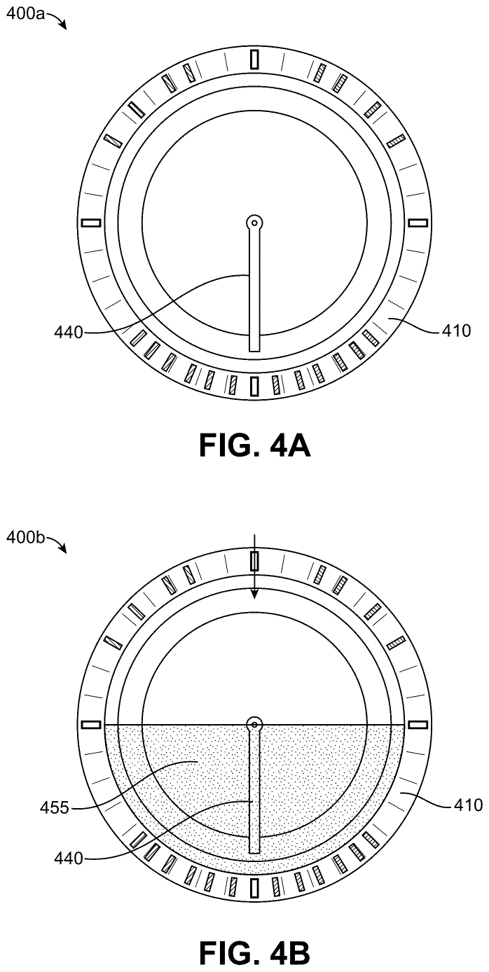

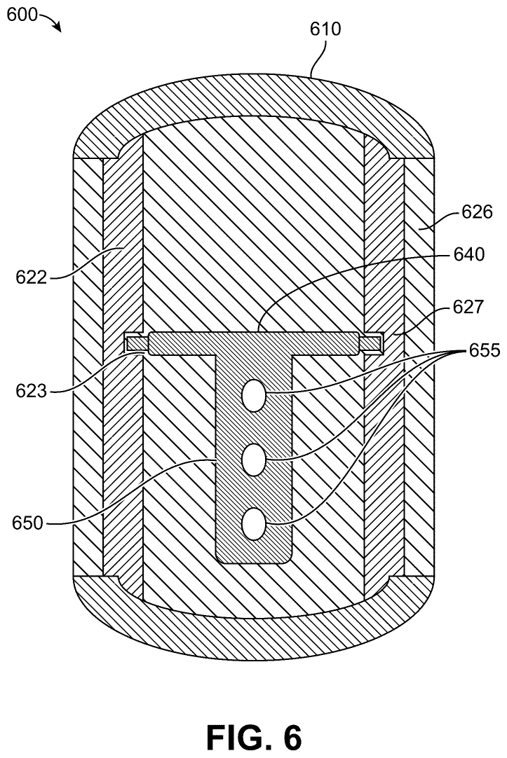

Across the figure set, FIGS. 1A-1B illustrate an example of the core geometry and pendulum assembly in a configuration of the combined plumb and level measurement apparatus utilizing separate chambers for the plumb measurement/indication and for the level measurement/indication (e.g., a central circular chamber with a pendulum for the plumb measurement/indication, and an annular ring-shaped chamber with a 50% fluid fill disposed about the circumference of the inner, circular plumb measurement/indication chamber and configured for use in providing the horizontal level measurement/indication of the apparatus); FIGS. 2A-2C depict examples of a single-chamber half-fill configuration; FIGS. 3A-3B illustrate examples of the single chamber combined plumb and level measurement vial with integration (or retrofitting) into a straight edge frame; FIGS. 4A-4B illustrate examples of exterior indicia cooperating with the pendulum and liquid interface of the combined plumb and level measurement apparatus (e.g., single vial configuration, etc.); FIGS. 5A-5B illustrate example operational views of readings taken from the same single vial combined plumb and level measurement apparatus; and FIG. 6 illustrates an example of a pendulum for plumb measurement or indication utilizing an ear-tab suspension with drag management features.

FIG. 1A is a diagram illustrating an example front view 100a and an example side view 130a of a measurement apparatus including a pendulum-based plumb indication and fluid-based level indication, in accordance with some examples. For example, the measurement apparatus may be implemented as a circular measurement apparatus comprising a sealed housing 110 incorporating an annular fluid chamber for level indication (e.g., the fluid-based level indication), and a centrally suspended pendulum 140 for plumb indication (e.g., the pendulum-based plumb indication). For example, the pendulum 140 (also shown in the enlarged view of FIG. 1B) can be suspended, pinned, mounted, rotationally coupled, etc., to a housing 110 of the apparatus, where the mount point of the pendulum 140 is located at a midpoint along a diameter of the circular housing 110 of the apparatus. Accordingly, the length of the pendulum 140 can be less than or equal to the inner radius (e.g., radius of the inner diameter) of the enclosure or aperture within which the pendulum 140 is disposed. In some aspects, the side view 130a illustrates packaging depth and wall structure, noting that specific dimensions and wall thickness may vary.

In some examples, the annular fluid chamber 110 surrounds a central cavity of the plumb and level measurement apparatus, and may be viewed or understood as conceptually divided into a lower fluid-filled portion 112 and an upper portion 118, where the horizontal level reference line or plane 115 corresponds to the surface of the fluid when the chamber is filled to about one-half, and a centrally located pendulum 140 aligns with the vertical plumb line or plane 145. The term annular fluid chamber, as used herein, may refer to a sealed ring-shaped volume circumscribing a central opening and configured to confine the damping liquid in a geometry that forms opposed fluid columns readable as a level reference. Examples of such annular fluid chambers can include, but are not limited to, an integrally molded ring channel in a plastic housing, a machined metal ring with an internal groove closed by a transparent lens, and/or a glass ring sealed to front and back plates, etc., among various others.

The term level reference plane, as used herein, may refer to the horizontal plane defined by the upper surface of the fluid within the chamber when the fill ratio is at about one-half of the enclosed volume. Examples of such level references can include, but are not limited to, a straight interface visible across a circular window, opposed fluid menisci in a ring channel, and/or a superimposed reference line (e.g., external indicia or marking, etc.) on a transparent face aligned with the fluid interface, etc., among various others. The term plumb reference plane, as used herein, may be used to refer to the vertical plane that passes through the geometric center of the housing and along which the pendulum aligns at rest under gravity. Examples of such plumb references can include, but are not limited to, a centerline established by aligned cardinal marks at 12 and 6 o'clock, a printed vertical reference on a lens, and/or an internal rib aligned with housing markings, etc., among various others.

The pendulum 140 can be included in the plumb measurement portion of the apparatus, as introduced above. For example, the pendulum 140 can rotate freely about the pinned mount or attachment point 142, such that the pendulum 140 comes to rest or equilibrium aligned in the direction of gravity. In some aspects, the resting or equilibrium position of the pendulum 140 (e.g., in the radial direction from the pinned mount point 142) corresponds to the plumb line/plane 145, which is shown in the example of FIG. 1A as the perfectly vertical direction. The angular displacement or deviation of the pendulum 140 from the plumb line 145 when at rest or equilibrium can indicate the angular displacement of a straight edge of the disclosed measurement apparatus from the plumb line 145, thereby enabling the measurement and alignment of a desired object, surface, edge, etc., in the plumb line 145 direction.

In some embodiments, the pendulum 140 can be located within an aperture (e.g., cylindrical volume) about the center of an annular housing 110 of the combined plumb and level measurement apparatus. For example, the housing 110 can be puck or disc shaped, with a diameter that is greater than its depth, as can be seen in the example front and side views shown in FIG. 1A. In some embodiments, the housing 110 of the apparatus can have a diameter of approximately 1 to 2 inches, although it is noted various other dimensions or sizes, both larger and/or smaller, may also be utilized without departing from the scope of the disclosure. In some examples, the apparatus housing 110 can have a diameter of between 1½ inches to 2 inches. The diameter may be an inner diameter or an outer diameter measurement of the housing 110. In some examples, the depth of the housing 110 (e.g., into the page with respect to the front view 100a of FIG. 1A, left-to-right with respect to the side view 130a of FIG. 1A) is less than the diameter of the housing 110, as noted above. In some embodiments, the depth of the housing 110 can be approximately ½ inch. In some cases, the depth of the housing 110 is approximately 1 inch or less. In another illustrative example, the depth of the housing 110 can be less than or equal to 50% the diameter of the housing 110, less than or equal to 25% the diameter of the housing 110, etc.

The housing 110 can be implemented as an airtight housing, such that the volume that contains the pendulum 140 is separated from and does not mix with the ambient environment surrounding the apparatus. In some embodiments, the housing 110 for the pendulum 140 may contain (e.g., comprise) vacuum. In some embodiments, the housing 110 for the pendulum 140 may be partially or fully filled with one or more fluids, liquids, gases, etc. For example, the inner volume of the housing 110 containing pendulum 140 can be filled with a liquid or fluid having a viscosity that is greater than the viscosity of the ambient air or environment. The fluid(s) and/or the respective viscosity of each fluid may be selected to provide a damping force or damping effect on the swinging motion of the pendulum 140. For instance, by suitably selecting the viscosity of the fluid fill within the inner chamber of the housing 110 that contains the pendulum 140, the pendulum 140 can be damped to more quickly settle at the equilibrium position with respect to the plumb line 145 as dictated or driven by the orientation of the pendulum 140 and measurement apparatus with respect to the local gravity vector, etc.

In some cases, the housing 110 of pendulum 140 can be filled with a fluid that has a viscosity greater than water. In some embodiments, the housing 110 of pendulum 140 is filled with a fluid other than water. For instance, the fluid may be selected based on having an increased viscosity for damping the rotation or sway of the pendulum 140, as noted above, and may additionally be selected based on the thermal behavior(s) and/or characteristics of the fluid when exposed to temperatures at or beyond one or more (or both) of a minimum expected/desired operating temperature range for the apparatus, and a maximum expected/desired operating temperature range for the apparatus.

In one illustrative example, the fluid for filling the housing 110 and empty volume surrounding the pendulum 140 can be selected based on the fluid being resistant to or not undergoing a state change within a configured operating range of the measurement apparatus. For example, the fluid may be selected based on the fluid having a freezing point that is below the freezing point of water. The fluid may be selected to minimize, avoid, prevent, etc., fogging, evaporating, etc., from liquid into gas within the housing 110 of the apparatus. In some embodiments, the fluid for filling the inner chamber surrounding the pendulum 140 is selected to have a sufficient viscosity for damping the pendulum rotation or movement as desired, and is further selected to not be affected by heat or cold (e.g., changing or varying temperatures) within the desired operating range of the measurement apparatus disclosed herein, such that the fluid does not freeze or fog. In some embodiments, the disclosed plumb and level measurement apparatus can comprise a transparent or translucent material for the housing 110. The housing material can have a wall thickness that is approximately equal to 1/16^{th} of an inch, although greater or lesser thickness (e.g., thicker or thinner housing walls) may also be used without departing from the scope of the disclosure.

In some aspects, the pendulum 140 can comprise a solid material having a material composition selected as a single material, a composite material, etc. In some aspects, the pendulum 140 is suspended by the pinned attachment point 142 from the exact center of the housing 110 of the apparatus, as shown in FIGS. 1A and 1B. The pendulum 140 can swing freely from the pinned attachment 142, such that one distal end of the pendulum 140 is pinned to the center of the housing 110, while the other distal end of the pendulum 140 does not come in to contact with the inner wall/surface of the housing 110 (e.g., based on the longitudinal length of the pendulum 140 being less than the inner radius of the housing 110 by a configured tolerance, gap, distance, etc. designed to enable the unobstructed swinging or rotating movement of the pendulum 140 during use).

In some aspects, the pinned attachment point 142 may also be referred to interchangeably herein as a “pivot point” and/or “pivot opening” 142. For example, FIG. 1B details a pendulum assembly 150 comprising the pendulum 140 with pivot opening 142 provided at a first distal end along the longitudinal length of the pendulum 140 (e.g., the longitudinal length of pendulum 140 comprising the vertical orientation or direction in the perspective of FIG. 1B, etc.). In some embodiments, the pivot opening 142 of the pendulum 140 may be positioned within the housing 110 of the combined plumb and level measurement apparatus to coincide with the geometric center of the circular housing 110 (e.g., disposed at or proximate the geometric center of the sealed chamber of circular housing), such that the pendulum 140 may rotate through 360° and with clearance relative to the inner wall of the chamber enclosed by the housing 110 (e.g., when the pendulum 140 is installed via the pivot opening 142, etc.).

In some aspects, the term pivot opening, as used herein, may refer to an aperture or bearing seat formed in the pendulum 140 that receives a support element (coupled to or integrally formed with the housing 110) to establish a rotational axis for gravity alignment and plumb measurement/indication via the pendulum 140. In some embodiments, examples of such pivot openings can include, but are not limited to, a through-hole for a pin, a countersunk bore with a bushing, and/or a jewel seat configured for low-friction rotation, etc., among various others. In examples where the pendulum 140 is implemented with one or more fluorescent edges and/or faces, the term fluorescent edge(s) and/or fluorescent face(s), as used herein, may refer to a high-visibility treatment applied along a margin (e.g., edge and/or face) of the pendulum 140 to improve visual contrast against the housing 110 and fluid during alignment or other operation and/or usage of the disclosed plumb and level measurement apparatus by a user thereof. Examples of such fluorescent edges can include, without limitation, coatings with fluorescent paint, bright powder-coated finishes, and/or high-contrast polymer overlays, etc., among various others. The term clearance gap, as used herein, can refer to the radial spacing between the distal end of the pendulum 140 and the inner surface of the housing 110, sized to allow free rotation without contact. Examples of the clearance gap may comprise or correspond to, without limitation, one or more of a uniform radial gap set by the inner radius, a tapered pendulum profile that preserves spacing at extremes of swing, and/or a chamfered inner wall feature that maintain a non-contact condition, etc., among various others.

In one illustrative example, the pendulum 140 can have a thickness of approximately 1/16^{th} of an inch, although it is again noted that a larger or smaller dimensional value could also be used within the scope of the disclosure (e.g., thicker or thinner construction of the pendulum 140). The thickness of the pendulum may refer to the left-right measurement across the pendulum 140 in the front view 100a shown in FIG. 1A. In some aspects, the pendulum 140 can be implemented with a size/dimensions that are selected in combination with the material choice and/or density thereof used for constructing or manufacturing the pendulum 140. For instance, the pendulum 140 can be provided such that the pendulum 140 is heavier than the liquid or fluid fill that is provided within the enclosed central chamber of the housing 110, as discussed above. For example, the pendulum 140 can be made heavier by increasing the dimensions of the pendulum 140 while keeping density the same, by increasing the density of the pendulum 140 material composition while keeping the dimensions the same, and/or various combinations of changing both the dimensions/volume and the density/material composition used for the pendulum 140, etc.

The tolerance between the longitudinal length of the pendulum 140 and the inner radius of the central chamber of the housing 110 containing the pendulum 140 and fluid fill can be relatively small, so that the free distal end of the pendulum 140 is maintained within a tolerable distance of the circumference (inner/outer wall) of the housing 110. For example, the pendulum 140 can be approximately the same length as the inner radius of the housing 110 to allow easier and/or more accurate or precise visual verification or comparison of the position of the pendulum 140 when at rest or equilibrium position, relative to one or more marking on the exterior of the housing 110 that indicate different angular displacements from the plumb line 145 and/or that indicate the plumb line 145 itself. For example, the exterior of the housing 110 can have angle markings at both 90° and 180° increments, corresponding to the 12 o'clock, 3 o'clock, 6 o'clock, 9 o'clock positions about the circumference of the housing 110 of the disclosed plumb and level apparatus, etc.

In some examples, the markings provided on the exterior (e.g., outer face or surface) of the housing 110 of pendulum 140 can be sized to be the same width as the pendulum 140. For example, in the front view 100a shown in FIG. 1A, the width of the marking shown at the 6 o'clock position on the outer surface of the pendulum housing 110 is exactly equal to the width of the pendulum 140. In some examples, the markings provided on the exterior of the housing 110 of the pendulum 140 can be permanent marks. For example, the angle markings can be permanently embossed in the housing 110 at 90° and 180° offsets, as well as other offsets and angle values along the circumference, etc. In some aspects, the angle markings on the outer surface of the housing 110 can be fluorescent or high-contrast material, paint, ink, dye, etc.

In some aspects, one or more edges and/or faces of the pendulum 140 can comprise a fluorescent material or substance (or a non-fluorescent material having a coating applied thereupon of a fluorescent paint, material, substance, etc.) that improves visibility of the pendulum 140 by a user of the apparatus in dark and/or low-light conditions, etc. In some examples, the pendulum 140 can be painted, marked, coated, etc., with a high visibility material that contrasts with a color of the fluid used to fill the inner housing 110 chamber within which the pendulum 140 resides (e.g., such as the fluid 255 illustrated as filling the chamber of the inner housing 210 of FIG. 2, etc., which may be the same as or similar to the enclosed chamber of the inner housing 110, etc.). In some examples, the pendulum 140 can have a fluorescent coating that is the same as a material or paint used to mark one or more positions on the outer surface of the housing 110 of the apparatus (e.g., the angle markings at the 90° and 180° offset positions around the circumference of the housing 110, etc.). In some examples, the pendulum 140 can have a fluorescent coating that is different from and/or contrasts with, a paint or coating material used to mark the angles and/or to provide other measurement indicia on the housing 110 face.

In some aspects, the level measurement portion of the apparatus can be provided on, in, within, integrated with, attached to, etc., the same housing 110 that is associated with the plumb measurement portion and the pendulum 140. For example, the level measurement portion of the apparatus can correspond to the annular ring or circular tube that is disposed about the outer surface (e.g., along the circumference) of the housing 110 containing the pendulum 140 and the filled liquid for providing damping to the pendulum 140. In some embodiments, the level measurement portion of the apparatus can be an annular ring or circular tube that is integrally formed with the housing 110 of the pendulum 140. In other examples, the level measurement portion of the apparatus can be a separate component that is attached, coupled, bonded, etc., to the outer surface of the housing 110 of the pendulum 140.

In some aspects, the level measurement portion of the apparatus can comprise a fluid level (e.g., a water level, etc.). The water level can be used to provide or measure a level alignment with the horizontal level line or plane 115, shown in FIG. 1A as being perpendicular/orthogonal to the plumb line/plane 145. In some examples, the plumb line/plane corresponds to a vertical direction or orientation of alignment, and the level line/plane 115 corresponds to a horizontal direction or orientation of alignment. In one illustrative example, the level measurement portion of the apparatus comprises the circular or annular enclosed (e.g., sealed) tubing about the circumference of the housing 110 of the pendulum 140, where the annular tubing is filled 50% with a first liquid having a given viscosity. By filling the annular tubing to exactly 50% of the total enclosed volume with the first fluid, the maximum height of the enclosed first fluid can represent or otherwise indicate the horizontal level line/plane 115 regardless of the orientation of the disclosed apparatus. The deviation between the level line 115 formed between the left and right maximum height of the liquid within the annular tubing (e.g., the level line 115 formed between the top of the fluid within the enclosed tubing at the left hand side of FIG. 1A, and the top of the same continuous body of fluid within the enclosed tubing at the right hand side of FIG. 1A, etc.).

Notably, the water level portion of the disclosed apparatus can be used to determine an alignment with the horizontal level line/plane 115 (or a deviation from the horizontal level line/plane 115) without utilizing or relying upon a bubble of air, as in conventional air bubble-based alignment and/or leveling device(s). Instead, the height of the fluid filled to 50% of the enclosed volume of the annular water level chamber can be used to determine the horizontal alignment measurement based on the height and position of the surface of the liquid or fluid filled within the lower 50% of the enclosed volume of the annular water level chamber (e.g., the lower annular volume 112, which is equal in volume to the upper annular volume 118, both shown in FIG. 1A).

In some examples, the annular ring comprising the upper and lower portions 118, 112 (respectively) to form the water level portion of the apparatus may be filled using a fluid that is the same as or similar to the fluid used to fill the pendulum 140 chamber and provide damping. In other examples, the water level portion of the apparatus can be filled using a different fluid than the pendulum 140 chamber fluid. In some embodiments, the lower portion 112 of the annular chamber for the water level can be exactly 50% of the total volume of the annular chamber (e.g., equal volumes for the lower portion 112 and upper portion 118). The fluid used to fill the lower portion 112 of the annular water level chamber can be selected to minimize or avoid undesirable or degraded performance at high and low temperature, such that the fluid does not freeze or fog. In some embodiments, the annular water level chamber can be vacuum sealed, such that the lower portion 112 comprises the 50% fluid fill and the upper portion 118 comprises vacuum. In other examples, the lower portion 112 can be filled with a first fluid, while the upper portion 118 can be filled with a second fluid that is different from the first fluid. In some embodiments, the first and second fluid can be non-miscible (e.g., immiscible) liquids or fluids (e.g., the lower portion 112 and the upper portion 118 of the annular water level chamber or tubing can be filled with two non-miscible or immiscible fluids or liquids). In some cases, the lower portion 112 of the water level chamber is filled with a fluid and the upper portion 118 of the water level chamber is filled with a gas.

In some aspects, the systems and techniques described herein for a combined plumb and level measurement apparatus can be seen to provide redundant measurement capabilities by utilizing both the gravity-based pendulum action associated with the pendulum 140 of the plumb alignment portion, and by utilizing the artesian well-type technique or action associated with the height of the fluid level within the annular chamber (e.g., the 50% fluid fill within the annular chamber or other chamber used for the water level will move within the annular tubing according to the principle of water seeking its own level, with the surface formed by the first fluid across the diameter of the water level chamber aligning with the horizontal level line/plane 115).

In some embodiments, the pendulum-based plumb measurement portion of the apparatus and the fluid-based level measurement portion of the apparatus can correspond to separate chambers (e.g., enclosed volumes) include in the apparatus. For instance, the vertical/plumb measurement or indication portion of the apparatus can correspond to the pendulum chamber at the center of the apparatus housing 110 (e.g., disposed at or proximate the geometric center of the sealed chamber of circular housing), and the horizontal level measurement or indication portion of the apparatus can correspond to the annular chamber at the circumference or edge of the apparatus housing 110.

In some embodiments, the pendulum-based plumb measurement portion of the apparatus and the fluid-based level measurement portion of the apparatus can be combined into a single (e.g., same) chamber enclosed by or within the apparatus housing (e.g., housing 110, etc.). For example, in some embodiments the combined plumb and level measurement apparatus can be implemented by filling the inner chamber of the housing 110 (e.g., the empty volume enclosed by the housing 110, and including the pendulum 140) with a fluid that occupies exactly 50% of the total enclosed volume of the housing 110 chamber in which the pendulum 140 is disposed. In other examples, the fluid fill level may be within the range of 40%-60% of the total enclosed volume of the sealed chamber within the housing 110 of the plumb and level measurement apparatus disclosed herein. Examples of embodiments where the plumb measurement/indication portion and the level measurement/indication portion of the apparatus are combined into a single chamber are shown in the examples of FIGS. 2A-6, and are described in greater detail below. In some aspects, the single chamber or single volume implementation of the combined plumb and level measurement apparatus may also be referred to herein as a plumb-and-level vial, or plumb-and-level chamber, etc., among various others.

For example, FIGS. 2A through 2C illustrate various views and/or configurations of single sealed chamber (e.g., single vial combined plumb and level measurement apparatus) embodiment in which the pendulum 240 (and/or 240c) and fill liquid 255 reside within the same enclosure (e.g., the inner volume of the single vial enclosed by the housing 210, etc.). In the examples of FIGS. 2A-2C, FIG. 2A illustrates a view of the combined plumb and level measurement apparatus 200a prior to filling with fluid for the horizontal level measurement/indication, where a circular housing 210 encloses a centrally suspended pendulum 240 for the plumb measurement/indication. FIG. 2B shows a view of the combined plumb and level measurement apparatus 200b in a fluid-filled state or configuration, with a centrally suspended pendulum 240 for plumb indication and a sealed chamber half filled with liquid (e.g., fluid) 255 to define a lower liquid portion and an upper gas headspace that provide the fluid-based level reference via the horizontal level line or plane 215 formed from the interface therebetween.

The term headspace, as used herein, can be used to refer to the non-liquid portion of the sealed chamber above the liquid fill 255, and which may be seen to permit free movement of the fluid interface of the horizontal level line 215, as well as free movement of the pendulum 240. Examples of such headspaces (e.g., corresponding to the upper gas headspace above the horizontal level line 215 and the fluid fill 255 within the enclosed chamber of the combined plumb and level measurement vial described herein) can include, but are not limited to, vacuum headspace, dry air headspace, and/or inert gas headspace such as nitrogen, etc., among various others.

A fill-then-extract approach or technique, as used herein, may refer to a manufacturing technique in which the chamber is filled substantially completely with liquid and then a portion is withdrawn to establish the target half-fill ratio for the fluid fill 255 shown in the filled configuration of FIG. 2B, as well as to remove entrained air. Examples of fill-then-extract techniques can include, but are not limited to, techniques such as syringe withdrawal after full fill, vacuum draw-down followed by sealing, and/or metered dispense into a closed chamber with subsequent relief of excess liquid, etc., among various others. The term resealable fill port, as used herein, can refer to an aperture configured to be accessed during filling and then closed to maintain a seal during service or subsequent use of the combined plumb and level measurement vial in the fluid filled configuration such as the example shown in FIG. 2B, etc. Examples of resealable fill ports may include, but are not limited to, an elastomeric self-sealing septum, a threaded plug with an elastomeric gasket, and/or a welded or bonded cap applied after manufacture processing, etc., among various others. For example embodiments utilizing a self-sealing septum to implement the resealable fill port for providing the fluid fill 255, the term self-sealing septum, as used herein, may refer to an elastomeric element that reseals after needle penetration to maintain airtight integrity, although it is noted various other implementations and configurations may also be used without departing from the scope of the present disclosure. Illustrative examples of such self-sealing septa may include, without limitation, silicone rubber disks, butyl rubber plugs, and/or polyurethane membranes sized for needle gauges used in production, etc., among various others.

FIG. 2A is a diagram illustrating a front view 200a of a plumb and level measurement apparatus having a combined or integrated design where the pendulum 240 (e.g., for plumb measurement/alignment) and the filled fluid level portion (e.g., for horizontal level measurement/alignment) are provided within the single, same enclosed volume of the housing 210. In some aspects, the front view 200a of FIG. 2A corresponds to a first configuration of the combined plumb and level measurement apparatus, prior to fluid filling of the enclosed housing 210 in which the centrally suspended pendulum 240 is disposed. In some aspects, the front view 200a of FIG. 2A depicts a housing 210 that is the same as the housing 110 of the pendulum 140 shown in the front view of FIG. 1A. In some aspects, the housing 210 of FIG. 2A is the same as the housing 210 shown in FIG. 2B, and may be the same as or similar to the housing 110 of FIG. 1A. In some aspects, the pendulum 240 of FIG. 2A is the same as the pendulum 240 of FIG. 2B, and may be the same as or similar to the pendulum 140 shown in FIGS. 1A and 1B.

FIG. 2B illustrates the front view 200b of the combined plumb and level measurement apparatus of FIG. 2A, where a portion of the interior, enclosed volume of the housing 210 is filled with a liquid (e.g., fluid) 255. In particular, the front view 200b of FIG. 2B corresponds to a filled configuration of the combined plumb and level measurement apparatus, using the centrally suspended pendulum 240 for plumb indication for the combined plumb and level measurement apparatus, and using the sealed (e.g., enclosed) interior chamber of the housing 210—half-filled with fluid or liquid—to define a lower liquid portion and an upper gas headspace to thereby provide the fluid-based level reference for the combined plumb and level measurement apparatus disclosed herein.

In some embodiments, the fill level for the filled liquid/fluid 255 can be a 50% fill level of fluid (e.g., and/or a 40%-60% fluid fill, etc.) used to implement the horizontal level measurement or alignment, where the surface of the liquid 255 filled within the single chamber enclosed by the housing 210 of the apparatus provides alignment with and a visual reference for a horizontal level line/plane 215 (e.g., which may be the same as or similar to the horizontal level line/plane 115 of FIG. 1A, etc.).

FIG. 2C illustrates another front view 200c of the combined plumb and level measurement apparatus of FIGS. 2A and 2B (and/or FIG. 1A), depicting the housing 210 with an enclosed inner volume including a pendulum 240c, which may be similar to and/or may correspond to one or more of the pendulum 140 of FIGS. 1A-1B, and/or the pendulum 240 of FIGS. 2A-2B, etc.). In some embodiments, the front view 200c of FIG. 2C depicts an alternative configuration of the combined plumb and level measurement apparatus based on using an elongated pendulum 240c (e.g., elongated relative to a length of the example pendulum 240 shown in FIGS. 2A and/or 2B, etc.), where the elongation of the pendulum 240c in the configuration of FIG. 2C corresponds to a reduction in the tolerance or free space gap between the distal end of the pendulum 240c and the inner wall of the enclosed chamber of the housing 210.

In some aspects, the pendulum 240c is suspended at the center of the housing 210 (e.g., at or along a midpoint of the diameter of the housing 210, etc.), with a suitable gap or clearance for free 360° rotation of the pendulum 240c without contacting the inner surface of the housing 210. In some aspects, the pendulum 240c is suspended and/or disposed at or proximate the geometric center of the sealed chamber of the housing 210. For example, the length of the pendulum 240c (e.g., the longitudinal length of the pendulum 240c extending from the attachment point at which the pendulum 240c is suspended at the center of the housing 210, to the distal end of the pendulum 240c that is adjacent to, without contacting, the inner surface of the housing 210) can be equal to ½ the inner diameter (ID) of the enclosed volume of the housing 210, minus the gap or clearance space between the distal end of the pendulum 240c and the inner wall or interior surface of the enclosed volume of the housing 210.

As noted previously, the systems and techniques herein can be used to provide a combined plumb and level measurement apparatus, in various form factors, integrations, and/or implementations. In some embodiments, the combined plumb and level measurement apparatus may utilize separate chambers within a circular housing, with a first chamber used for providing a gravity-based plumb measurement or indication using a pendulum, and with a second chamber used for providing a gravity-based, fluid-level measurement or indication using a 50% fluid fill within the second chamber. In an illustrative example, the combined plumb and level measurement apparatus using separate chambers for the plumb measurement or indication via pendulum, and for the level measurement or indication via 50% fluid fill (e.g., and/or a 40%-60% fluid fill, etc.) can correspond to the example(s) of FIGS. 1A and/or 1B, etc.

In another illustrative example, the systems and techniques herein may be used to provide a combined plumb and level measurement apparatus using a single chamber (also referred to as a vial) within a circular housing, where the single chamber (e.g., vial) includes both the gravity-based plumb measurement or indication assembly including the pendulum, and also includes the fluid-based horizontal level measurement or indication assembly. For example, the fluid fill can be provided in the same chamber as the pendulum, corresponding to a single vial form factor of the combined plumb and level housing. In some aspects, the single vial form factor of the combined plumb and level housing may also be referred to as a single vial plumb and level measurement apparatus, or a single plumb and level measurement vial, and/or a plumb-and-level vial, etc., among various others. As noted previously, in some embodiments the disclosed plumb-and-level vial may be integrally formed with a straight edge frame or measurement edge, device, apparatus, etc., may be removably attached or coupled to a straight edge frame or measurement edge, device, apparatus, etc., and/or may be configured for retrofitting via attachment, insertion, coupling, bonding, etc., with a variety of different straight edge frames, measurement edges, devices, apparatuses, etc., among various other receptacles that may be sized, configured, or adapted to hold and/or receive the disclosed plumb-and-level vial described herein.

FIG. 3A illustrates a first perspective view 300a of a combined plumb and level measurement apparatus integrated into a straight edge frame 370, with a circular housing 310 including (e.g., enclosing) a centrally suspended pendulum 340 and configured for fluid filling to thereby implement the fluid-based level measurement as noted previously above. FIG. 3B illustrates a second perspective view 300b of the combined plumb and level measurement apparatus integrated into the straight edge frame 370, with the circular housing 310 and pendulum 340 the same as those shown in FIG. 3A, respectively. In some aspects, the circular housing 310 of FIGS. 3A and 3B can be the same as or similar to one or more of the housing 110 of FIG. 1A, the housing 210 of FIGS. 2A-2C, etc. In some aspects, the centrally suspended pendulum 340 of FIGS. 3A and 3B can be the same as or similar to one or more of the pendulum 140 of FIGS. 1A-1B, the pendulum 240 of FIGS. 2A-2B, and/or the pendulum 240c of FIG. 2C, etc.

In an illustrative example, FIGS. 3A and 3B depict integrated embodiments 300a and 300b in which a circular housing 310 containing the pendulum 340 and fluid is mounted within a straight edge frame 370 so that the pendulum 340 and liquid interface are visible from the user-facing side(s) while the frame 370 provides straight reference surfaces for placement on workpieces or other surfaces for the plumb and/or level measurement or indication provided by the combined plumb and level measurement vial herein (e.g., the circular housing 310 comprising the combined plumb and level measurement vial). The term transparent face, as used herein, may refer to a window or lens that closes the chamber and permits visual reading of the pendulum 340 and fluid interface from outside the housing 310. Examples of transparent faces can include, but are not limited to, tempered glass windows, polycarbonate lenses, and/or acrylic covers coupled to the housing 310, etc., among various others. The term coupling interface, as used herein, may refer to mechanical features or components by which the combined plumb and level vial housing 310 is secured to the frame 370 while maintaining visibility and sealing. Examples of coupling interfaces may include, without limitation, press-fit rims with elastomeric gaskets, mechanical retainers or clamps, adhesive bonding to a receiver ring, and/or various fasteners (e.g., configured to pass through mounting flanges on the housing 310, etc.), among various others, etc.

In some aspects, the straight edge frame 370 can be implemented as an I-beam profile or similar structural shape having at least one straight edge surface that is aligned parallel to the horizontal level line or plane when the combined plumb and level measurement apparatus 300a/300b indicates a level alignment condition. In some embodiments, the circular housing 310 can be disposed within an aperture or opening formed in the straight edge frame 370, such that the circular housing 310 is visible from both sides of the straight edge frame 370. In some embodiments, the straight edge frame 370 can include straight edge surfaces on opposing sides of the circular housing 310, thereby enabling accurate alignment measurements against workpieces or surfaces positioned against either side of the straight edge frame 370. The circular housing 310 can be integrally welded, bonded, press-fit, or otherwise permanently affixed to the straight edge frame 370 during manufacture.

In other embodiments, the circular housing 310 (e.g., the plumb-and-level vial) can be configured for retrofitting into existing straight edge tools, levels, or similar devices by designing the outer dimensions of the circular housing 310 to correspond to standard vial sizes used in conventional bubble level tools. In some aspects, the pendulum 340 is visible through a transparent or translucent front face of the circular housing 310, and an outer ring or bezel of the circular housing 310 can include angle markings, pitch markings, and/or other measurement indicia (e.g., as described in further detail below with reference to FIGS. 4A and 4B, among others). The perspective views 300a and 300b of FIGS. 3A and 3B, respectively, illustrate that the pendulum 340 hangs vertically downward from the central suspension point under the influence of gravity, thereby providing a plumb indication regardless of the angular orientation of the straight edge frame 370 relative to the horizontal level line or plane.

FIGS. 4A and 4B illustrate exterior indicia on housing 410 that may be used cooperatively with one or more of the plumb measurement/indication provided by the pendulum 440 and/or the level measurement/indication provided by the liquid-filled lower portion of the vial with the fluid fill 455, to thereby provide multiple measurement modes and/or modalities for the disclosed plumb and level measurement vial apparatus, for instance with primary ticks at the 12, 3, 6, and 9 o'clock positions and additional scales for angular and pitch readings about the circumferential edge(s) of the housing 410. The term pitch scale, as used herein, can refer to a set of exterior indicia that correlates angular displacement to, for example, roof-slope style ratios for construction tasks. Examples of such pitch scales may include, but are not limited to, ticks corresponding to 2/12, 4/12, 6/12, 8/12, 10/12, and 12/12 ratios with optional numeric labels, etc., among various others. The term angle (or angular) scale, as used herein, can refer to a set of exterior indicia that correlates pendulum 440 alignment to discrete angular values used in layout and cutting tasks, among various others. Examples of such angle (angular) scales can include, without limitation, ticks corresponding to 22.5°, 30°, 45°, and 60° with numerals oriented for readability in different quadrants, etc., among various other combinations of scales, numerical values, ranges, offsets, etc. The term cardinal positions, as used herein, may be used to refer to the four primary reference locations spaced at right angles (e.g., 90° apart) around the circumference of housing 410, such that the cardinal position markings may be used, for example, to establish reference axes or positioning information, etc. Examples of such cardinal positions can include, without limitation, the 12, 3, 6, and 9 o'clock markings (e.g., corresponding to North, East, South, and West (respectively) in at least some examples), enlarged ticks at these locations, and/or color-contrasted indicators aligned with the housing centerlines, etc.

In particular, FIG. 4A is a diagram illustrating a front view 400a of the combined plumb and level measurement apparatus, depicting a circular housing 410 with exterior angle and pitch markings (e.g., indicia) and a centrally suspended pendulum 440. The front view 400a of FIG. 4A depicts a configuration prior to fluid filling of the enclosed chamber within the circular housing 410, where the pendulum 440 is visible through a transparent front face of the circular housing 410. In some aspects, the circular housing 410 includes an outer ring or bezel portion having a plurality of measurement markings disposed thereon. The measurement markings can include primary reference markings at the 12 o'clock, 3 o'clock, 6 o'clock, and 9 o'clock positions about the circumference of the circular housing 410, corresponding to the 0°, 90°, 180°, and 270° angular positions (e.g., cardinal positions), respectively. These primary (e.g., cardinal position) reference markings can be used to enable plumb and level measurements, for example where the pendulum 440 aligning with the 12 o'clock or 6 o'clock marking indicates plumb alignment (e.g., in the vertical direction), and where alignment of the gas-fluid interface 415 (e.g., between the upper gas headspace and the lower fluid fill 455, as shown in FIG. 4B) with the 3 o'clock and 9 o'clock markings indicating horizontal level alignment.

In some aspects, the plumb measurement or indication via the pendulum 440 can comprise or correspond to a first measurement modality of the disclosed plumb and level measurement apparatus, and the horizontal level measurement or indication via the fluid fill 455 and gas-fluid interface 415 can comprise or correspond to a second measurement modality of the disclosed plumb and level measurement apparatus. In some embodiments, the external indicia provided about the circumferential edge or face of the circular housing 410 can be configured to provide one or more additional measurement modalities for the disclosed plumb and level measurement apparatus. For instance, a third measurement modality can be provided by a plurality of roof-pitch markings or external indicia provided on a lower half or lower portion of the circumferential edge of the circular housing 410. In some examples, a fourth measurement modality can be provided by a plurality of angle/angular markings or external indicia provided on an upper half or upper portion of the circumferential edge of the circular housing 410.

In one illustrative example, the third measurement modality for roof-pitch measurement or indication can be provided based on the circular housing 410 further including a plurality of roof-pitch markings disposed in the lower half of the outer ring or bezel about the circumferential edge of the circular housing 410, corresponding to angular positions between the 3 o'clock position and the 9 o'clock position (e.g., traversing through the 6 o'clock position).

The roof-pitch markings can correspond to standard roof-pitch values commonly used in construction, including a 2/12 pitch at approximately 9.46° (e.g., corresponding to the indicia mark of ‘2’ in the examples of FIGS. 3A, 3B, 5A, and 5B); a 4/12 pitch at approximately 18.43° (e.g., corresponding to the indicia mark of ‘4’ in the examples of FIGS. 3A, 3B, 5A, and 5B); a 6/12 pitch at approximately 26.5° (e.g., corresponding to the indicia mark of ‘6’ in the examples of FIGS. 3A, 3B, 5A, and 5B); an 8/12 pitch at approximately 33.75° (e.g., corresponding to the indicia mark of ‘8’ in the examples of FIGS. 3A, 3B, 5A, and 5B); a 10/12 pitch at approximately 39.81° (e.g., corresponding to the indicia mark of ‘10’ in the examples of FIGS. 3A, 3B, 5A, and 5B); and a 12/12 pitch at approximately 45° (e.g., corresponding to the indicia mark of ‘12’ in the examples of FIGS. 3A, 3B, 5A, and 5B).

The roof-pitch markings may enable users of the combined plumb and level measurement apparatus disclosed herein to directly measure and set roof angles without requiring separate pitch calculation or conversion. In some embodiments, the circular housing 410 further includes a plurality of angle (e.g., angular) markings disposed in the upper half of the outer ring or bezel on the circumferential edge or face of the housing 410, where the plurality of angle/angular markings or indicia correspond to pre-determined or selected/configured angular positions between the 9 o'clock position and the 3 o'clock position (e.g., traversing through the 12 o'clock position) as shown in the examples of FIGS. 4A and 4B.

The angle markings can correspond to common construction angles, including 22.5°, 30°, 45°, and 60°, as is illustrated in the examples of the upper indicia about the circumferential edge of the housing 310 in the examples of FIGS. 3A and 3B, and as is also illustrated in the examples of the upper indicia about the circumferential edge of the housing 510 in the examples of FIGS. 5A and 5B. Providing the angle markings or indicia about the circumference of the housing of the disclosed plumb and level measurement vial may be seen to provide the fourth measurement or indication modality to users, as noted above, for instance by enabling users to measure and set standard miter cuts, bevel angles, and similar angular workpiece alignments.

In some aspects, the roof-pitch markings in the lower half of the housing 410 are oriented such that the numerical or symbolic pitch indicators are readable when the apparatus is positioned with the 6 o'clock position at the bottom, while the angle markings in the upper half of the housing 410 can be oriented upside-down relative to the plumb reference such that the numerical angle indicators are readable when the apparatus is inverted with the 12 o'clock position at the bottom. In some embodiments, the measurement markings on the circular housing 410 are integrally formed with the housing 410, such as by embossing, engraving, molding, or otherwise forming the markings as raised or recessed features in the housing material. Integrally formed markings may provide improved durability relative to painted or printed markings, as the integrally formed markings cannot be worn away or rubbed off during use. In some aspects, the integrally formed markings or indicia can be filled or highlighted with a paint, ink, dye, or other coloring material to improve visibility and contrast, and the coloring material can be reapplied if worn away while the underlying marking geometry remains intact. In some embodiments, a width of each marking on the circular housing 410 is equal to or substantially equal to a thickness of the pendulum 440, such that precise alignment can be verified when the pendulum 440 is exactly aligned with (e.g., aligned with or between both the left and right edges of) a given marking when viewed from the front of the circular housing 410.

FIG. 4B is a diagram illustrating another front view 400b of the combined plumb and level measurement apparatus of FIG. 4A, in a filled configuration where a fluid fill 455 is provided within the enclosed chamber of the circular housing 410 to thereby provide a horizontal level reference defined by the 50% fluid fill 455 (e.g., and/or a 40%-60% fluid fill, etc.) within the sealed circular housing 410 enclosed chamber. In some aspects, the fluid fill 455 is a colored or tinted liquid that contrasts with the color of the pendulum 440 and/or with a background color of the circular housing 410, thereby improving visibility of both the fluid level surface and the pendulum 440 position for a user of the apparatus. In some aspects, the combined plumb and level measurement apparatus of FIGS. 4A and 4B may be the same as or similar to, and/or may correspond to, one or more of the combined plumb and level measurement apparatuses of FIGS. 1A-3B.

In some aspects, the circular housing 410 can be the same as or similar to one or more of the housing 110 of FIG. 1A, the housing 210 of FIGS. 2A-2C, and/or the circular housing 310 of FIGS. 3A-3B, etc. In some aspects, the centrally suspended pendulum 440 of FIGS. 4A and 4B can be the same as or similar to one or more of the pendulum 140 of FIGS. 1A-1B, the pendulum 240 of FIGS. 2A-2B, the pendulum 240c of FIG. 2C, and/or the centrally suspended pendulum 340 of FIGS. 3A and 3B, etc. In some aspects, the fluid fill 455 of FIG. 4B can be the same as or similar to the fluid fill 255 of FIG. 2B, etc.

FIG. 5A is a front view 500a of a combined plumb and level measurement apparatus comprising a straight edge frame 570 with an integrated circular plumb-and-level vial housing 510, comprising an enclosed chamber (e.g., inner volume of the housing 510) with a centrally suspended pendulum 540 for plumb measurement and/or indication, and with a 50% fluid fill 555 (e.g., and/or a 40%-60% fluid fill, etc.) for level measurement and/or indication. In some aspects, the front view 500a of FIG. 5A depicts the combined plumb and level measurement apparatus in a first orientation where the straight edge frame 570 is positioned substantially horizontally (e.g., in a level alignment), such that the pendulum 540 hangs vertically downward from the central suspension point and aligns with the 6 o'clock marking on the circular plumb-and-level vial housing 510. The fluid fill 555 forms a horizontal surface that bisects the enclosed chamber of the housing 510, providing a visual reference for the horizontal level line or plane. In some embodiments, the circular plumb-and-level vial housing 510 includes an outer ring or bezel having a plurality of roof-pitch markings and angle markings as described previously with reference to FIGS. 4A and 4B. The outer ring can have an increased width relative to the transparent central viewing area of the housing 510, providing sufficient surface area for the plurality of pitch and angle markings while maintaining adequate visibility of the pendulum 540 and fluid fill 555 through the transparent center of the housing 510.

FIG. 5B is a front view 500b of a second configuration of the combined plumb and level measurement apparatus with the straight edge frame 570 and integrated circular plumb-and-level vial housing 510. In some aspects, the front view 500b of FIG. 5B depicts the combined plumb and level measurement apparatus in a condition where the pendulum 540 has not yet settled to an equilibrium position, and multiple ghost images or afterimages of the pendulum 540 are shown to illustrate the oscillating motion of the pendulum 540 as the pendulum 540 swings through decreasing arcs before coming to rest at the equilibrium position aligned with the direction of gravity. In some embodiments, the viscosity of the fluid fill 555 is selected to provide damping of the pendulum 540 oscillation, such that the pendulum 540 settles to the equilibrium position within a desired time period (e.g., within a few seconds) rather than continuing to oscillate for an extended duration. The damping provided by the fluid fill 555 also prevents excessive overshoot when the pendulum 540 is displaced from the equilibrium position and released, enabling rapid and stable alignment measurements.

FIGS. 5A and 5B depict example operational views of the disclosed plumb and level measurement vial (e.g., apparatus), in which a circular housing 510 installed in a straight edge frame 570 encloses a combined pendulum and fluid chamber, with liquid 555 occupying the lower half to establish a horizontal reading for level indication, while the pendulum 540 provides a plumb indication and can be observed at various angular positions relative to exterior indicia about the circumferential edge or face of the circular housing 510. The term operational state, as used herein, can refer to an orientation and/or placement condition of the tool (e.g., the plumb and level measurement vial, or straight edge or other tool including the plumb and level measurement vial, etc.) while one or more readings are taken from the vial. Examples of such operational states may include, but are not limited to, scenarios where the frame 570 is held plumb against a vertical surface, the frame 570 is laid level on a horizontal surface, and/or the frame 570 is positioned at a selected angle for layout while the pendulum 540 is read against the exterior markings, etc., among various others.

The plumb and level measurement vial of FIGS. 5A and 5B can be the same as or similar to the plumb and level measurement vial of one or more of FIGS. 1A-4B, for example with the centrally suspended pendulum 540 for plumb measurement and/or indication, and with the 50% fluid fill 555 (e.g., and/or a 40%-60% fluid fill, etc.) for level measurement and/or indication. FIG. 5B is a front view 500b of a second configuration of the combined plumb and level measurement apparatus with the straight edge frame 570 and integrated circular plumb-and-level vial housing 510. In some aspects, the straight edge frame 570 of FIGS. 5A and 5B can be the same as or similar to the straight edge frame 370 of FIGS. 3A and 3B. In some aspects, the circular plumb-and-level vial housing 510 of FIGS. 5A and 5B can be the same as or similar to one or more of the housing 110 of FIG. 1A, the housing 210 of FIGS. 2A-2C, the circular housing 310 of FIGS. 3A-3B, and/or the circular housing 410 of FIGS. 4A-4B, etc. In some aspects, the centrally suspended pendulum 540 of FIGS. 5A and 5B can be the same as or similar to one or more of the pendulum 140 of FIGS. 1A-1B, the pendulum 240 of FIGS. 2A-2B, the pendulum 240c of FIG. 2C, the centrally suspended pendulum 340 of FIGS. 3A and 3B, and/or the centrally suspended pendulum 440 of FIGS. 4A and 4B, etc. In some aspects, the fluid fill 555 of FIGS. 5A and 5B can be the same as or similar to one or more of the fluid fill 255 of FIG. 2B and/or the fluid fill 455 of FIG. 4B, etc.

In some aspects, the front view 500a of FIG. 5A depicts the combined plumb and level measurement apparatus in a first orientation where the straight edge frame 570 is positioned substantially horizontally (e.g., in a level alignment), such that the pendulum 540 hangs vertically downward from the central suspension point and aligns with the 6 o'clock marking (e.g., external indicia) on the circumferential edge or face of the circular plumb-and-level vial housing 510. The fluid fill 555 forms a horizontal surface comprising a gas-fluid interface between the vacuum or gas headspace (e.g., including a gas and/or reduced-pressure vacuum space (e.g., partial vacuum) at sub-atmospheric pressure and occupying the headspace) in the upper portion of the enclosed vial within the housing 510, and the 50% fluid fill 555 (e.g., and/or a 40%-60% fluid fill, etc.) in the lower portion of the enclosed vial within the housing 510. The horizontal surface of the gas-fluid interface can comprise a horizontal reference line or horizontal reference plane for providing the level measurement or indication of the combined plumb and level measurement apparatus, where the horizontal surface of the gas-fluid interface bisects the enclosed chamber of the housing 510, thereby providing a visual reference for the horizontal level line or plane.

In some embodiments, the circular plumb-and-level vial housing 510 includes an outer ring or bezel having a plurality of roof-pitch markings and angle markings as described previously with reference to FIGS. 4A and 4B (e.g., and as also shown in the examples of FIGS. 3A and 3B, etc.). In some aspects, the outer circumferential ring or bezel of the housing 510 (e.g., whereupon the external indicia or markings are provided) can have an increased width relative to the circumferential rim about the transparent central viewing area of the housing 510, so as to provide sufficient surface area for the plurality of pitch and angle markings while maintaining adequate visibility of the pendulum 540 and fluid fill 555 through the transparent center of the housing 510.

FIG. 5B is a front view 500b of a second configuration of the combined plumb and level measurement apparatus with the straight edge frame 570 and integrated circular plumb-and-level vial housing 510. In some aspects, the front view 500b of FIG. 5B depicts the combined plumb and level measurement apparatus in a condition where the pendulum 540 has not yet settled to an equilibrium position, and multiple ghost images or afterimages of the pendulum 540 are shown to illustrate the oscillating motion of the pendulum 540 as the pendulum 540 swings through decreasing arcs before coming to rest at the equilibrium position aligned with the direction of gravity. In some embodiments, the viscosity of the fluid fill 555 is selected to provide damping of the pendulum 540 oscillation, such that the pendulum 540 settles to the equilibrium position within a desired time period (e.g., within a few seconds) rather than continuing to oscillate for an extended duration. The damping provided by the fluid fill 555 also prevents excessive overshoot when the pendulum 540 is displaced from the equilibrium position and released, enabling rapid and stable alignment measurements.

FIG. 6 is a cross-sectional view 600 of the combined plumb and level measurement apparatus including a pendulum 640 including a pendulum body portion 650 with one or more drag-reducing apertures 655 (e.g., also referred to as openings, holes, through-holes, etc.), where the pendulum body portion 650 is suspended by a crossbar with distal ends 623 and 627 that form left and right pendulum “ear” tabs, respectively, that are received in corresponding recesses of left and right walls (e.g., the opposing interior faces) 622, 626 of the enclosed chamber within the housing 610 of the combined plumb and level measurement apparatus. In some aspects, the crossbar of the pendulum 640 may be oriented in a perpendicular (e.g., orthogonal) fashion relative to the pendulum body portion 650, for example such that an approximately 90° is formed therebetween, etc.

In some cases, the first distal end 623 of the pendulum 640 crossbar may also be referred to as a first, or a left, pendulum ear tab 623; the second distal end 627 of the pendulum 640 crossbar may also be referred to as a second, or a right, pendulum ear tab 627. The left pendulum ear tab 623 and the right pendulum ear tab 627 can be received in the corresponding recesses of the first (e.g., left) housing wall 622 and the second (e.g., right) housing wall 626 to thereby define a central pivot axis of the pendulum 640, without the use of a central support column anchoring the pendulum 640 to a point anywhere about the circumference of the circular housing 610 or enclosed interior volume thereof. In some aspects, the corresponding recesses for receiving the left pendulum ear tab 623 and the right pendulum ear tab 627 are provided as indentations or detents in the first/left and second/right housing walls 622 and 626, respectively. For example, the recesses can be sunk into the first/left and second/right housing walls 622 and 626, respectively, which may comprise the two transparent faces of the circular housing 610, as noted previously above.

In some aspects, the cross-sectional view 600 of FIG. 6 illustrates an internal construction of the plumb-and-level vial, depicting the manner in which the pendulum 640 is suspended at the center of the housing 610 (e.g., disposed at or proximate the geometric center of the sealed chamber of circular housing 610, etc.) and the structural features that enable free rotation of the pendulum 640 in response to gravitational force. In some aspects, the pendulum 640 includes a main body portion 650 that extends from the suspension point at or proximate the geometric center of the housing 610 toward the inner circumference of the enclosed chamber. The main body portion 650 of the pendulum 640 has a longitudinal length that is less than the inner radius of the housing 610 by a clearance gap that permits the distal end of the main body portion 650 to rotate freely without contacting the inner wall of the housing 610. In some embodiments, the pendulum 640 includes a lateral support member (e.g., a crossbar, horizontal arm, or similar structural element, etc.) extending laterally from an upper portion of the main body 650, and the ear tabs 623, 627 extend from opposing, distal ends of the lateral support member (e.g., crossbar) of the pendulum 640. The ear tabs 623, 627 may be configured to engage corresponding depressions, divots, grooves, or recesses formed in the opposing interior faces 622, 626 of the housing 610, thereby suspending the pendulum 640 at the center of the housing 610 (e.g., disposed at or proximate the geometric center of the sealed chamber of circular housing 610, etc.) while permitting the pendulum 640 to rotate about an axis passing through the ear tabs 623, 627.

In some aspects, each ear tab 623, 627 has a thickness of approximately 1/32 inch, and the corresponding depression in each interior face 622, 626 has a depth that is approximately equal to or slightly greater than the ear tab thickness. The engagement between the ear tabs 623, 627 and the depressions in the interior faces 622, 626 provides a low-friction pivot point that enables the pendulum 640 to rotate freely through a full 360° range of motion in response to changes in the orientation of the apparatus relative to the gravitational direction. In some embodiments, the interior faces 622, 626 can be implemented as glass, acrylic, polycarbonate, and/or various other transparent or translucent material(s) that permits visual observation of the pendulum 640 position from outside the housing 610, etc. In some embodiments, the depressions for receiving the ear tabs 623, 627 in the interior faces 622, 626 can be formed by molding, machining, etching, and/or various other suitable manufacturing processes that produce precisely dimensioned and positioned recesses for receiving the ear tabs 623, 627 of the pendulum 640.

As noted above, in some embodiments the body portion 650 of the pendulum 640 may include one or more drag-reducing apertures 655, which in the example of FIG. 6 are shown as being implemented as three aligned, equally sized circular openings (e.g., apertures) 655, although it is noted various other combinations, alignments, sizes, geometries, shapes, etc., may also be utilized for the one or more drag-reducing apertures 655, without departing from the scope of the present disclosure. In an illustrative example, the drag-reducing apertures 655 may be disposed on the main body portion 650 of the pendulum 640, and used or configured to permit the fluid fill (e.g., the 50% fluid fill and/or a 40%-60% fluid fill, etc., used for the horizontal level measurement or indication via the gas-fluid interface bisecting the enclosed chamber of the combined plumb and level measurement vial disclosed herein, etc.) within the enclosed chamber of the housing 610 to pass through the pendulum 640 (e.g., via the openings provided by the drag-reducing apertures 655) as the pendulum 640 rotates, thereby reducing the hydrodynamic drag force that would otherwise resist the rotational motion of a solid pendulum body moving through the viscous fluid fill.

In the example of FIG. 6, three drag-reducing apertures 655 are shown arranged in a vertical column along the length of the main body portion 650, although other numbers and arrangements of drag-reducing apertures 655 may also be used. In some embodiments, the number, size, shape, and arrangement of the drag-reducing apertures 655 can be selected based on the viscosity of the fluid fill used within the housing 610, the mass and dimensions of the pendulum 640, and/or the desired settling time for the pendulum 640 to reach equilibrium after being displaced. In some aspects, the drag-reducing apertures 655 may be circular, oval, elongated slot-shaped, or other suitable shapes that provide the desired fluid passage while maintaining sufficient structural integrity of the main body portion 650 of the pendulum 640.

In some embodiments, the pendulum 640 is manufactured from a metal material such as stainless steel, which provides high density for rapid settling under gravitational force, corrosion resistance for compatibility with various fluid fill materials, and long-term durability without degradation or material shedding that could contaminate the fluid fill. A stainless steel construction of the pendulum 640 may be used, in at least some embodiments, to ensure that the pendulum 640 maintains consistent mass and dimensions over the operational lifetime of the combined plumb and level measurement apparatus, thereby preserving measurement accuracy across repeated use and/or various different use case scenarios. In some aspects, one or more edges of the pendulum 640 can include a fluorescent coating or material that improves visibility of the pendulum 640 position in low-light conditions. The fluorescent edge can contrast with the color of the fluid fill within the housing 610, further enhancing visibility for a user of the apparatus.

In some aspects, the housing 610 of FIG. 6 can be the same as or similar to one or more of the housing 110 of FIG. 1A, the housing 210 of FIGS. 2A-2C, the circular housing 310 of FIGS. 3A-3B, the circular housing 410 of FIGS. 4A-4B, and/or the circular plumb-and-level vial housing 510 of FIGS. 5A and 5B, etc. In some aspects, the pendulum 640 of FIG. 6 can be the same as or similar to one or more of the pendulum 140 of FIGS. 1A-1B, the pendulum 240 of FIGS. 2A-2B, the pendulum 240c of FIG. 2C, the centrally suspended pendulum 340 of FIGS. 3A and 3B, the centrally suspended pendulum 440 of FIGS. 4A and 4B, and/or the centrally suspended pendulum 540 of FIGS. 5A and 5B, etc.

In some embodiments, a filling process for providing or achieving the 50% fluid fill and the gas-fluid interface for the horizontal level line or plane for the level measurement or indication functionality provided by the disclosed combined plumb and level measurement apparatus can include filling the enclosed chamber of the housing (e.g., housing 110, 210, 310, 410, 510, and/or 610, etc.) to 100% capacity with a fluid, and then extracting approximately 50% of the fluid volume to achieve the desired 50% fill level. By initially filling the chamber to 100% capacity and then extracting fluid, the upper portion of the enclosed chamber (e.g., the headspace above the fluid fill surface) is evacuated to a partial vacuum condition (e.g., reduced-pressure vacuum space at sub-atmospheric pressure, etc.). The partial vacuum in the headspace can enable the fluid fill to move freely within the enclosed chamber in response to changes in the orientation of the apparatus, without resistance from a trapped air pocket that would impede fluid movement.

In some aspects, the fluid used to fill the enclosed chamber can be selected to have a freezing point below the freezing point of water, such that the apparatus remains functional in cold weather conditions without the fluid fill solidifying (e.g., without the fluid fill freezing, etc.). Example fluids suitable for the fluid fill can include, but are not limited to, antifreeze, glycol-based fluids, mineral oil, and/or other fluids having low freezing points and suitable viscosity characteristics. In some aspects, the fluid used for the fluid fill of the enclosed chamber (e.g., vial) of the disclosed combined plumb and level measurement apparatus may be selected to have a boiling point above the maximum expected operating temperature of the apparatus, preventing fogging, evaporation, or bubble formation within the enclosed chamber during use.

In some embodiments, the enclosed chamber includes a fill port that enables introduction of the fluid fill during manufacturing. The fill port can be sealed after the filling process is complete to maintain the airtight or vacuum condition of the headspace (e.g., including a partial vacuum and/or reduced-pressure vacuum space at a sub-atmospheric pressure occupying the headspace above the fluid fill within the sealed chamber, etc.). In some aspects, the fill port includes a self-sealing membrane, septum, or plug made of rubber, silicone, or similar elastomeric material. The self-sealing membrane can be penetrated by a needle or syringe to inject fluid into the enclosed chamber and to extract fluid from the enclosed chamber, and the elastomeric material self-seals when the needle is withdrawn, maintaining the airtight seal without requiring additional plugging or sealing steps. In some embodiments, the fill port is located in a region of the housing that does not interfere with visual observation of the pendulum or fluid level surface through the transparent front face of the housing.

In some aspects, the combined plumb and level measurement apparatus can be manufactured as a standalone plumb-and-level vial that is configured for retrofitting into existing straight edge tools, levels, or similar measurement devices. The plumb-and-level vial can have outer dimensions that correspond to standard vial sizes used in conventional bubble level tools, enabling the plumb-and-level vial to replace a conventional bubble vial in an existing tool without requiring modification to the tool housing or mounting structure. In some embodiments, the plumb-and-level vial can be manufactured as a separate component that is provided independently of any straight edge frame or tool body, enabling end users or tool manufacturers to integrate the plumb-and-level vial into various different tools and devices according to the specific application requirements. In some aspects, the plumb-and-level vial can be integrated into a straight edge frame (e.g., straight edge frame 370 or 570, etc.) during original manufacture of a complete plumb and level measurement tool, providing a factory-assembled tool that is ready for use upon purchase.

Notably, the presently disclosed apparatus for plumb and level measurements described herein can be used to provide convenient, redundant, and accurate indications of plumb alignment and/or level alignment from a single circular opening or aperture of a straight edge tool that includes or integrates the disclosed apparatus. The apparatus can be sized for use in a hand tool or other small form factor, and can have a diameter of between 1-2 inches (e.g., among various other sizes or diameters, including larger and smaller diameter values, etc.). In some aspects, the integrated design can be seen to allow both plumb and level measurements to be taken from a single aperture or circular opening included in a straight edge or similar hand tool, improving upon conventional bubble levels that require separate chambers and bubble vials the respective plumb and level measurements. The disclosed apparatus for combined plumb and level measurement additionally provides improved usability and redundancy by utilizing two different principles of level alignment, namely the gravity-based design of the pendulum 140 and the artesian well or displacement-based design of the annular chamber (comprising 112 and 118) of the water level. Advantageously, the disclosed combined plumb and level measurement apparatus described herein can maintain the accuracy advantages of traditional plumb bobs and water levels while providing these capabilities in a compact, portable form factor suitable for integration into hand tools.

These and other embodiments of the invention will be apparent to the skilled person and the invention is not limited to the foregoing examples.

1. A measurement apparatus comprising:
a housing defining a sealed chamber and a viewing window, the viewing window comprising at least one transparent face of the housing;
a fluid disposed within the sealed chamber to occupy a first portion of a volume of the sealed chamber, wherein a fluid interface between the fluid and a headspace above the fluid provides a level reference across the viewing window;
a pendulum disposed within the sealed chamber and pivotably supported for rotation about a pivot axis located at or proximate a geometric center of the sealed chamber, wherein at least a portion of the pendulum extends through the fluid, and wherein the pendulum is configured to align with a direction of gravity independently of an orientation of the housing to provide a plumb reference visible through the viewing window concurrently with the level reference provided by the fluid interface; and
a plurality of exterior indicia disposed along a circumference of the housing and adjacent the viewing window, the plurality of exterior indicia including at least: a first pair of opposed level reference marks corresponding to the level reference, and a second pair of opposed plumb reference marks angularly offset from the first pair of opposed level reference marks.

2. The measurement apparatus of claim 1, wherein the pendulum is visible through the viewing window and is configured to align with the direction of gravity independently of the orientation of the housing such that the measurement apparatus concurrently provides the plumb reference by the pendulum and the level reference by the fluid interface.

3. The measurement apparatus of claim 1, wherein the fluid interface provides the level reference based on the fluid interface forming a horizontal reference plane across the viewing window in response to a gravitational force in the direction of gravity with which the pendulum is configured to align.

4. The measurement apparatus of claim 1, wherein a longitudinal length of the pendulum is less than an inner radius of the sealed chamber by a clearance gap configured to permit free 360-degree rotation of the pendulum without contact between a distal end of the pendulum and an inner wall of the sealed chamber.

5. The measurement apparatus of claim 1, wherein the pendulum comprises a body portion having one or more drag-reducing apertures configured to permit the fluid to pass through the pendulum during rotation of the pendulum about the pivot axis and within the sealed chamber.

6. The measurement apparatus of claim 5, wherein a surface area corresponding to the drag-reducing apertures is greater than or equal to half of a total surface area of the body portion of the pendulum.

7. The measurement apparatus of claim 1, wherein the pendulum comprises a fluorescent material or includes at least one fluorescent edge or surface to provide increased contrast relative to the fluid occupying the first portion of the volume of the sealed chamber.

8. The measurement apparatus of claim 1, further comprising a pivot support coupled to the housing and engaged with the pendulum to pivotably support the rotation of the pendulum about the pivot axis, wherein the pivot support aligns a first distal end of the pendulum with the pivot axis.

9. The measurement apparatus of claim 8, wherein the pivot support comprises a column having a first distal end coupled to the housing along an inner surface of the sealed chamber and having a second distal end disposed at or proximate the geometric center of the sealed chamber, wherein the pendulum is rotatably coupled to the pivot support at the second distal end of the column.

10. The measurement apparatus of claim 8, wherein the pivot axis and the pivot support extend between a first attachment point located at or proximate the geometric center along a first transparent face of the housing and a second attachment point located at or proximate the geometric center along a second transparent face of the housing, and wherein the first and second transparent faces comprise the viewing window.

11. The measurement apparatus of claim 1, wherein the pendulum is pivotably supported for rotation by a crossbar aligned with the pivot axis and extending between a first recess located at or proximate the geometric center on a first transparent face of the viewing window, and a second recess located at or proximate the geometric center on a second transparent face of the viewing window.

12. The measurement apparatus of claim 11, wherein:
the pendulum comprises the crossbar and a pendulum body perpendicular to the crossbar;
a first distal end of the crossbar is configured for engagement within the first recess on the first transparent face; and
a second distal end of the crossbar is configured for engagement within the second recess on the second transparent face.

13. The measurement apparatus of claim 1, wherein the plurality of exterior indicia further includes at least one of:
a set of roof-pitch reference marks disposed about a lower portion of the circumference of the housing and adjacent the viewing window, wherein the set of roof-pitch reference marks includes respective indicia corresponding to at least two pitches selected from the group consisting of 2/12 pitch, 4/12 pitch, 6/12 pitch, 8/12 pitch, 10/12 pitch, and 12/12 pitch; and
an angle scale comprising a set of angular reference marks disposed about an upper portion of the circumference of the housing and adjacent the viewing window, wherein the set of angular reference marks includes respective indicia corresponding to at least two angular values selected from the group consisting of 22.5 degrees, 30 degrees, 45 degrees, and 60 degrees.

14. The measurement apparatus of claim 1, wherein:
the plurality of exterior indicia include at least cardinal markings corresponding to 0-degrees, 90-degrees, 180-degrees, and 270-degrees about the circumference of the housing; and
the first pair of opposed level reference marks and the second pair of opposed plumb reference marks are selected from the group consisting of the cardinal markings.

15. The measurement apparatus of claim 1, wherein at least a portion of the exterior indicia are integrally formed with an exterior surface of the housing, and wherein a width of at least one marking included in the plurality of exterior indicia is equal to a thickness of the pendulum.

16. The measurement apparatus of claim 1, wherein:
the fluid interface is formed between the fluid occupying the first portion of the volume of the sealed chamber and a second fluid occupying the headspace above the first fluid, the headspace comprising a remaining portion of the volume of the sealed chamber; and
the fluid and the second fluid are non-miscible to thereby provide the fluid interface as a substantially horizontal liquid interface across the transparent face of the viewing window when the measurement apparatus is at rest.

17. The measurement apparatus of claim 1, wherein the level reference comprises a horizontal reference plane defined by a gas-fluid interface between the fluid occupying the first portion of the volume and a gas or reduced-pressure vacuum space at sub-atmospheric pressure occupying the headspace above the fluid and having a density less than a density of the fluid.

18. The measurement apparatus of claim 1, wherein:
the fluid disposed within the sealed chamber has a viscosity selected to damp rotational motion of the pendulum toward a stable alignment;
the fluid disposed within the sealed chamber has a freezing point below a freezing point of water; and
the fluid disposed within the sealed chamber occupies between 40 percent and 60 percent of a total internal volume of the sealed chamber.

19. The measurement apparatus of claim 1, wherein the housing includes a resealable fill port in fluid communication with the sealed chamber, the resealable fill port extending between the volume of the sealed chamber and an exterior surface of the housing.

20. The measurement apparatus of claim 19, wherein the resealable fill port comprises a self-sealing elastomeric septum configured to be penetrated by a needle or tubular filling device for at least one of filling the sealed chamber by introducing a volume of the fluid via the resealable fill port, or removing a portion of an introduced volume of the fluid via the resealable fill port to thereby provide the headspace above the fluid.
